(19) United States
(12) Patent Application Publication
(10) Pub. No.: US 2021/0355977 A1
(43) Pub. Date: Nov. 18, 2021

(54) Anchoring Device

(71) Applicant: Robert Bosch GmbH, Stuttgart (DE)

(72) Inventors: Miriam Kederer, Zuchwil (CH); Uwe Wostradowski, Weil Der Stadt-Merklingen (DE); Tjalf Pirk, Stuttgart (DE); Fabian Purkl, Rutesheim (DE); Ricardo Ehrenpfordt, Zwickau (DE); Wolfgang Pleuger, Zuchwil (CH); Michael Curcic, Stuttgart (DE)

(21) Appl. No.: 17/262,290

(22) PCT Filed: Jul. 15, 2019
(86) PCT No.: PCT/EP2019/068981

§ 371 Date: Jan. 22, 2021

(30) Foreign Application Priority Data
Jul. 27, 2018 (DE) 10 2018 212 558.9

(51) Int. Cl. F16B 13/06; G01L 5/24

(52) U.S. Cl. CPC F16B 13/063; G01L 5/246

(57) ABSTRACT

An anchoring device, in particular to a bolt anchor or an expansion anchor, includes a communication interface via which at least one item of information can be made available to an external device. It is proposed that the communication interface have at least one surface wave unit for generating an acoustic surface wave.

### PRIOR ART

Described in WO 2013/113586 is an anchor system that has a sensor for sensing an axial end position of an expansion sleeve.

### DISCLOSURE OF THE INVENTION

The invention relates to an anchor device, in particular a bolt anchor or an expansion plug, having a communication interface via which at least one item of information can be provided to an external device. It is proposed that the communication interface have at least one surface-wave unit for generating a surface acoustic wave. Advantageously, a powerful communication interface may be realized by means of the surface-wave unit.

An anchor device is to be understood to mean, in particular, a component or an arrangement of components for the tension-safe connection or anchoring of components. The anchor device is preferably made of a high-tensile material, preferably metal. The anchor device is designed to be fastened in a drill hole. In particular, the anchor device is designed be connected in a non-positive and/or positive manner to the material in which the drill hole is arranged in a. Alternatively, it is also conceivable that the anchor device can be connected in a materially bonded manner to the material in which the drill hole is arranged. The drill hole is realized, in particular, as a substantially cylindrical drill hole.

The communication interface is realized, in particular, as a passive communication interface. A “passive” communication interface in this case is to be understood to mean, in particular, a communication interface that does not have an integrated, or its own, energy supply and that can be activated contactlessly by the external device. The communication interface is designed, in particular, to emit information in the form of an electrical signal, or transmit it to the external device. Preferably, all surface-wave units are of a passive design.

The information may be, for example, identification information by which the anchor device can be identified. The identification information may be, for example, type, model, manufacturer information and/or a unique identification. Furthermore, it is also conceivable for the information to be realized as anchor information, workpiece information or the like. The anchor information may be, for example, information that can be used to characterize the state of the anchor device, for example whether the anchor device is sufficiently strongly fastened in the drill hole, whether the anchor device is correctly positioned, whether the anchor device is mechanically tensioned and/or whether deformation or corrosion of the anchor device has occurred. The workpiece information may be, for example, a temperature or humidity of the workpiece in which the anchor device is fastened.

The external device has a communication interface via which an electrical signal can be generated for data exchange. The external device is realized, in particular, as a battery-operated external device. The external device may be realized, for example, as a hand-held power tool, which is provided in particular for generating the drill hole or for fastening the anchor device. The hand-held power tool may be realized as a drill, as an impact drill, as a hammer drill, as a screwdriver, as a rotary percussion screwdriver or the like. It is also conceivable for the external device to be realized as a device specifically provided for reading-out the anchor device, or the communication interface of the anchor device. It is also conceivable for the external device to be realized as a smartphone or a mobile computer, such as a laptop. Alternatively, it is conceivable for the external device to be realized as a stationary unit that is installed in the region of at least one anchor device, preferably in a region having a plurality of anchor devices. Via the external device realized as a stationary unit, a plurality of anchor devices can advantageously be checked periodically by means of the communication interfaces in order to ensure that the anchoring is secure.

The information provided via the communication interface can be monitored and evaluated during and/or after the setting of the anchor device, in order to store it in an infrastructure or write it to a memory element connected to the communication interface. When anchor device is being set, the anchor device may be monitored, in particular, via an external device realized as a hand-held power tool. Alternatively, the monitoring, or the reading-out and evaluation, may also be effected at a distance of some meters by means of a mobile external device. It is conceivable, for example, for the storage element to be realized as an RFID element and to be designed to be modified and/or written to by tools or hand-held power tools placed close to the anchor device.

Storing in this case is effected, for example, via a physical modification of a resistance or a capacitance, which in turn can be read-out by the communication interface. The information provided via the communication interface may also be retrieved at a later point in time, in particular changes in the state of the anchor device and/or of the workpiece may be monitored by means of the surface-wave unit.

A surface acoustic wave is to be understood to mean, in particular, a structure-borne sound wave that propagates in a planar manner on a surface, or substantially in two dimensions.

Furthermore, it is proposed that the surface-wave unit have a piezoelectric element and at least one first electrode structure, which are connected to each another in such a manner that an electrical and/or magnetic signal incoming, in particular, at the first electrode structure generates a surface acoustic wave, and/or a surface acoustic wave incoming, in particular, at the first electrode structure generates an outgoing electrical and/or magnetic signal. An electrical and magnetic signal in this case is to be understood to mean, in particular, an electromagnetic signal. The surface acoustic wave propagates, or spreads out, linearly. A piezoelectric element in this case is to be understood to mean, in particular, a piezoelectric material that generates an electrical voltage when deformed and, conversely, deforms elastically under an applied electrical voltage. The piezoelectric element may be composed of a piezoelectric crystal such as, for example, quartz, lithium niobate or gallium orthophosphate, or of a piezoelectric ceramic such as, for example, a lead zirconate titanate or a lead magnesium niobate. The electrode structure comprises electrical conductive elements, which may be metallic or made of graphite, for example. In particular, the electrode structure comprises two finger-like structures that engage in each other. The electrode structure is preferably arranged on the piezoelectric element, the electrode structure preferably lying on the piezoelectric element. In particular, the first electrode structure on the piezoelectric element forms an interdigital transducer. The electrical signal is realized, in particular, as an alternating voltage.

It is furthermore proposed that the surface-wave unit have at least one reflector element and/or one delay element. The reflector element and/or the delay element are/is arranged on the piezoelectric element of the surface-wave unit. The reflector element and/or the delay element preferably each have at least two electrically conductive elements that extend parallel to each another. The reflector element is designed to reflect the surface acoustic wave at least partially. The delay element is designed to delay a propagation of the surface wave. Preferably, the reflector element and the delay element are arranged in such a manner that the surface acoustic wave is influenced in such a manner that identification information can be provided by means of the generated electrical signal at the first electrode structure.

It is additionally proposed that the surface-wave unit have at least one second electrode structure, which is connected to a sensor. Advantageously, the surface-wave unit can thereby be coupled to a conventional sensor. The second electrode structure is arranged, in particular, on the same piezoelectric element as the first electrode structure. Preferably, the second electrode structure on the piezoelectric element forms a second interdigital transducer. The second electrode structure is, in particular, electrically connected to the sensor.

Furthermore, it is proposed that the sensor be designed to effect a change in a capacitance, an inductance and/or a resistance of the second electrode structure in dependence on a physical measured variable. Advantageously, the surface acoustic wave can thereby be changed in dependence on the physical measured variable. The physical measured variable may be realized, for example, as a humidity in the region of the surface-wave unit, a pressure or stress acting upon the surface-wave unit, a bending of the surface-wave unit, a vibration in the region of the surface-wave unit, a movement or deflection of the surface-wave unit, or the like. The sensor may be realized as a capacitive sensor, as an inductive sensor or as a resistive sensor. Furthermore, it is also conceivable for the sensor to be realized as a sound-based sensor.

It is furthermore proposed that the surface-wave unit have at least one reference element. The reference element has at least one electrical conductive element. The reference element may be identical in design to the second electrode structure and, in contrast to the second electrode structure, has no connection to a sensor. Advantageously, the reference element can be used to ascertain and compensate for environmental influences, in particular by comparing the surface acoustic wave or outgoing electrical signals reflected at the second electrode structure and at the reference element.

The anchor device may have one or more surface-wave units. The surface-wave units may be of the same or different design, “different” in this context meaning, in particular, that the surface-wave units have different sensors. It is also conceivable for an electrical signal outgoing from a surface-wave unit to be received as an incoming electrical signal by a further surface-wave unit; advantageously, the range of the electrical signal can thereby be increased.

It is additionally proposed that the anchor device have a main body that, in the fastened state, is arranged at least partially in a drill hole, wherein the surface-wave unit is arranged, in particular, on the main body. The main body has a fastening region that, in the fastened state, is arranged inside the drill hole. The surface-wave unit may be arranged on a circumferential surface of the main body or on an end face of the main body, preferably in the fastening region. Furthermore, the main body may have a free region that, in the fastened state, is arranged outside of the drill hole. In particular, in the free region the anchor device has a tension absorbing element, via which a tensile force can be applied to the main body. The tension absorbing element may be realized, for example, as a thread. The main body of the anchor device is preferably realized as a single component. Preferably, the surface-wave unit partially forms the outer surface of the main body. However, it is also conceivable for the surface-wave unit to be arranged at least partially, in particular completely, inside the main body.

Furthermore, it is proposed that the anchor device have at least one fastening element, which is designed to be movable relative to the main body, wherein the surface-wave unit is arranged on the fastening element. Advantageously, this makes it possible to measure the fastening strength as precisely as possible. The fastening element is preferably movably connected to the main body in the fastening region of the main body. The fastening element is realized, in particular, as an expansion element that moves radially outwards when a tensile force is applied to the main body. The surface-wave unit may be arranged between the fastening element and the main body. Alternatively, the surface-wave unit may also be arranged on a side that faces away from the main body. The surface-wave unit may partially form the outer surface of the fastening element or, alternatively, be arranged inside the fastening element.

Furthermore, the invention relates to a system composed of an anchor device as described above and of an elastic element, wherein the elastic element can be arranged in the drill hole in such a manner that the elastic element is in contact with the surface-wave unit. Advantageously, the elastic element provides an alternative way of measuring the fastening of the anchor device. In particular, the elastic element applies a force to the anchor device, or the surface-wave unit, when the anchor device has been fastened. The elastic element may be connected to the anchor device, for example by a material bond, so that the elastic element can be inserted into the drill hole together with the anchor device. Alternatively, it is also conceivable that first the elastic element and then, in a second step, the anchor device can be inserted into the drill hole. The elastic element may be realized as an elastic plastic, for example a rubber, as a gel or as an oil. Alternatively, it is conceivable for the elastic element to be realized as a balloon element. The balloon element preferably has an elastic sheath, made of plastic, in which there is a gas or a liquid.

The invention additionally relates to a washer or nut having a communication interface via which at least one item of information can be provided to an external device. It is proposed that the communication interface have at least one surface-wave unit for generating a surface acoustic wave. The washer and/or the nut are/is designed, in particular, for fastening the anchor device by means of the tension-absorbing element of the anchor device. Advantageously, the surface-wave unit is arranged on a side of the washer, or nut, that faces toward the nut, or washer, in order advantageously to ascertain a measurement of the contact force between the two components, via the surface-wave unit.

The invention furthermore relates to a method for transmitting information from an anchor device to an external device, comprising the following steps:
receiving of an electrical signal by the anchor device,
generation of a surface acoustic wave by the anchor device
sending of an electrical signal by the anchor device.

Furthermore, the invention relates to a method for reading-out information of an anchor device, comprising the following steps:
receiving of an electrical signal of a surface-wave unit of the anchor derive by an external device;
ascertainment of at least one item of information of the anchor device, based on the electrical signal, by the external device.

It is additionally proposed that the information be ascertained on the basis of a frequency, a velocity, a phase and/or an amplitude of the surface acoustic wave. Advantageously, one or more physical measured variables such as, for example, temperature, humidity, pressure, etc. in the region of the surface-wave unit on the anchor device can be ascertained from a change in the frequency, velocity, phase and/or amplitude of the surface acoustic wave.

Furthermore, the invention relates to an external device, which is configured to execute a method as described above.

### DRAWINGS

Further advantages are given by the following description of the drawings. The drawings, the description and the claims contain numerous features in combination. Persons skilled in the art will expediently also consider the features individually and combine them to form useful further combinations. References of features of different embodiments of the invention that substantially correspond to each other are denoted by the same number and by a letter identifying the embodiment.

In the figures:

FIG. 1a shows a side view of a first embodiment of an anchor device with a communication interface in the inserted state;

FIG. 1b shows a side view of the anchor device according to FIG. 1a in the fastened state;

FIG. 1c shows a section through the communication interface;

FIG. 1d shows a schematic layout of the surface-wave unit;

FIG. 2a shows a side view of a second embodiment of the anchor device;

FIG. 2b shows a schematic layout of a first surface-wave unit of the anchor device according to FIG. 2a;

FIG. 2c shows a schematic layout of a second surface-wave unit of the anchor device according to FIG. 2a;

FIG. 3 shows a schematic layout of a further alternative embodiment of a surface-wave unit;

FIG. 4 shows a side view of a system composed of an anchor device and of an elastic element.

### DESCRIPTION OF THE EXEMPLARY EMBODIMENTS

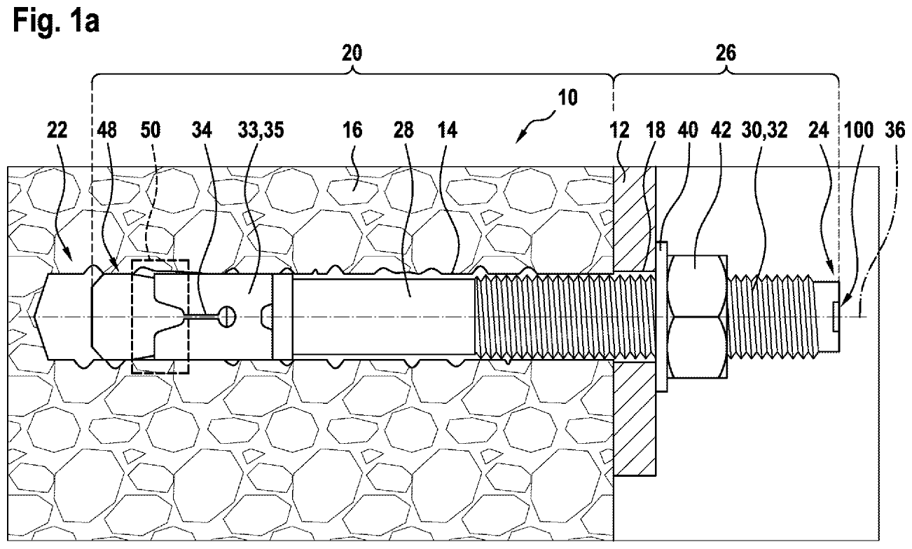

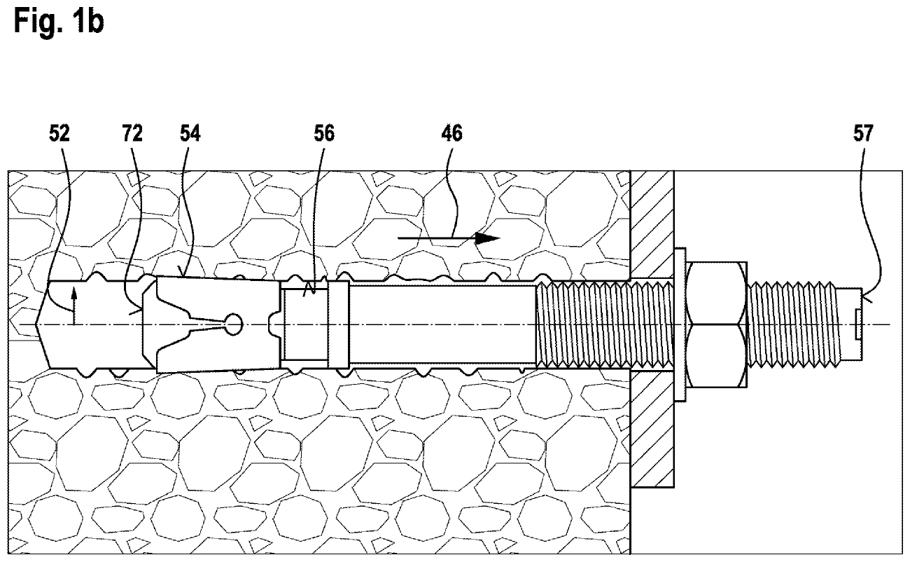

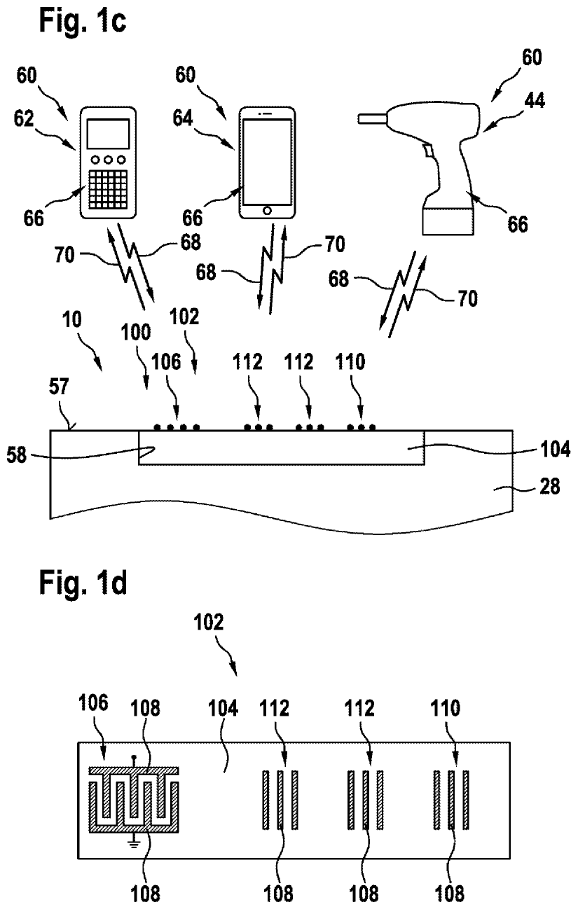

FIG. 1a and FIG. 1b each show a side view of an anchor device 10 according to the invention with a communication interface 100. The anchor device 10 is designed, in particular, for mounting heavy-duty components 12 on walls or ceilings. For this purpose, a drill hole 14 is first created in a workpiece 16 by means of a hand-held power tool (not represented) realized as a hammer drill. The workpiece 16 is realized, exemplarily, as a concrete wall. The anchor device 10 is composed of a metallic material, in particular high-grade steel.

For the purpose of mounting, the heavy-duty component 12 is first positioned on the wall. The anchor device 10 is guided into the drill hole 14 via a mounting opening 18 of the heavy-duty component 12, such that a fastening region 20 of the anchor device 10 is arranged inside the drill hole 14. The anchor device 10 has a front end 22 that, in the fastened state, is arranged in the drill hole 14. Furthermore, the anchor device 10 has a rear end 24 that is opposite to the front end 22. In the fastened state, the rear end 24 is arranged in a free region 26, which extends outside of the drill hole 14.

The anchor device 10 has a main body 28, which has a substantially cylindrical shape. The main body 28 extends from the fastening region 20 into the free region 26. In particular, the main body 28 extends from the front end 22 to the rear end 24 over the entire length of the anchor device 10. The main body 28 is realized, exemplarily, as one piece. In this context, as one piece is to be understood to mean, in particular, that the main body 28 is made from a single piece, and thus is not composed of a plurality of components connected to each another in a non-positive, positive and/or materially bonded manner. Alternatively, it would also be conceivable to realize the main body 28 as a plurality of pieces.

The main body 28 has a tension absorbing element 30 via which a tensile force can be applied to the main body 28. The tension absorbing element 30 is realized, exemplarily, as a thread 32, or as an external thread. Depending on the penetration depth of the anchor device 10 in the drill hole 14, the tension absorbing element 30 can be arranged partially or completely in the free region 26.

Furthermore, the anchor device 10 has a fastening element 33. The fastening element 33 is connected to the main body 28. In particular, the fastening element 33 is connected to the main body 28 in such a manner that the fastening element 33 can be moved relative to the main body 28. The fastening element 33 is mounted so as to be axially movable on the main body 28. The fastening element 33 has a substantially hollow cylindrical shape and encloses the main body 28 in the fastening region 20. The fastening element 33 is metallic, as is the main body 28. In particular, the anchor device 10 is composed of the main body 28 and the fastening element 33. The fastening element 33 is slotted. In particular, the fastening element 33 has two slots 34, which are preferably arranged opposite each other. The slots 34 extend parallel to a longitudinal axis 36 of the anchor device 10. The slots 34 begin on a front side of the fastening element 33 that faces toward the front end 22 of the anchor device 10. The length of the slots 34 is selected in such a manner that the fastening element 33 can be spread under the action of force. The length of the slots 34 may be in a range of between 10% and 90% of the length of the fastening element 33, and in the embodiment shown is, exemplarily, approximately 50% of the length of the fastening element 33. The fastening element 33 is realized, exemplarily, as an expansion sleeve 35.

FIG. 1a shows the anchor device 10 in the inserted state, in which the anchor device 10 is arranged in a detachable manner in the drill hole 14. FIG. 1b shows the anchor device 10 in the fastened state, in which the anchor device 10 is arranged in the drill hole 14 so as to be no longer detachable without use of tools. For the purpose of fastening, the anchor device 10 is first connected to a washer 40, which is pushed onto the main body 28, in particular onto the free region 26 of the main body 28. In a further step, a nut 42 is connected to the anchor device 10, in particular to the main body 28 of the anchor device 10. The nut 42 has an internal thread, not represented, which corresponds to the tension-absorbing element 30, realized as a thread 32, of the anchor device 10, or of the main body 28. The nut 42 is first screwed onto the anchor device 10 until the nut 42 is in contact with the washer 40, and the washer 40 is in contact with the heavy-duty component 12. A torque is then transmitted to the nut 42 by means of a tool, such as a spanner, or a hand-held power tool 44, such as a screwdriver, the torque acting upon the nut 42 being transmitted, via the tension-absorbing element 30, into a tensile force 46 acting upon the anchor device 10, in particular upon the main body 28 of the anchor device 10. The tensile force 46 causes the main body 28 to move out of the drill hole 14 to a small extent. In particular, the tensile force 46 causes an axial relative movement of the main body 28 relative to the fastening element 33.

The main body 28 of the anchor device 10 has a bulge 48 in the region of the front end 22. The outer diameter of the main body 28 is enlarged in the region of the bulge 48. Thus, the main body 28 has at least two regions with different outer diameters. In particular, the main body has a greater outer diameter in the region of the bulge 48 than in the region in which the main body 28 is enclosed by the fastening element 33 in the inserted state. A transition 50 between the lesser outer diameter and the greater diameter in the region of the bulge 48 is preferably realized continuously, and thus not abruptly. The transition 50 may be, for example, conical.

Owing to the the relative axial movement between the main body 28 and the fastening element 33, the bulge 48 at the front end 22 of the main body 28 moves in the direction of the fastening element 33. In particular, the bulge 48 is pushed into the fastening element 33 with the transition 50 foremost, the increasing outer diameter of the bulge 48, or of the transition 50, causing an outwardly acting, in particular radially outwardly acting, force 52 to act upon the fastening element 33.

This force 52 causes a radial relative movement of the fastening element 33 relative to the main body 28, which corresponds substantially to an expansion. Owing to the bulge 48 at the front end 22 of the main body 28 and the fastening element 33, realized as an expansion sleeve 35, the axially acting tensile force 46 can thus be converted into a radially acting force 52 that is designed to fasten the anchor device 10 in the drill hole. An outer surface 54 of the fastening element 33 applies a force, which is substantially proportional to the applied tensile force 46, to an inner surface 56 of the drill hole 14.

In this embodiment, the communication interface 100 of the anchor device 10 is arranged, exemplarily, in the region of the rear end 24. In particular, the communication interface 100 is arranged on a rear side 57 that extends substantially perpendicularly in relation to the longitudinal axis 36 of the anchor device 10. The communication interface 100 is embedded, exemplarily, in a recess 58 of the main body 28 of the anchor device 10. The communication interface 100 has a surface-wave unit 102 for generating a surface acoustic wave.

FIG. 1c shows a section through the communication interface 100 at the rear end 24 of the anchor device 10. FIG. 1d shows a schematic layout of the surface-wave unit 102. The surface-wave unit 102 is realized as a “one-port resonator” known to persons skilled in the art. The surface-wave unit 102 has a piezoelectric element 104 and a first electrode structure 106. The first electrode structure 106 is arranged on the piezoelectric element 104. In particular, the first electrode structure 106 lies on the piezoelectric element 104 and is materially bonded thereto. The piezoelectric element 104 is composed of a piezoelectric material, for example quartz. The first electrode structure 106 comprises two electrical conductive elements 108 which engage in each other in a finger-like manner. The electrical conductive elements 108 are made of a metal, for example gold. The first electrode structure 106 is realized as an interdigital transducer.

The first electrode structure 106 is realized in such a manner that an incoming electrical signal 68, for example an AC voltage, is converted into a surface acoustic wave that propagates on the piezoelectric element 104.

The incoming electrical signal 68 can be generated by an external device 60. The external device may be realized, for example, as a mobile reader 62, a smartphone 64 or as a hand-held power tool 44. The external device comprises a communication interface 66, via which an electrical signal 68 can be transmitted to the communication interface 100 of the anchor device 10 and/or an electrical signal 70 can be received from the communication interface 100 of the anchor device 10. Preferably, the external device 60 has at least one computing unit for processing the electrical signal 70, and the electrical signal 70 of the communication interface can be used to ascertain information. In this embodiment, the incoming and the outgoing signal 68, 70 are realized, exemplarily, as an electrical signal. Alternatively, it would also be conceivable for the incoming and the outgoing signal 68, 70 to be realized as a magnetic or an electromagnetic signal.

The surface-wave unit 102 additionally has a reflector element 110 for reflecting the surface acoustic wave. Furthermore, the surface-wave unit 102 has, by way of example, two delay elements 112, which are designed to partially reflect and/or to delay, or adapt, the characteristics of the surface acoustic wave. The delay elements 112 and the reflector element 110 are composed of electrical conductive elements 108, which are also exemplarily made of gold. The delay elements 112 and the reflector element 110 are mounted on the piezoelectric element 104.

The surface acoustic wave generated by the first electrode structure 106 is reflected back to the first electrode structure 106 by the delay elements 112 and the reflector element 110. The incoming surface acoustic wave at the first electrode structure 106 is converted into an outgoing electrical signal 70 that can be received by the external device 60. Information, for example realized as identification information, is provided via the outgoing electrical signal 70.

The number and arrangement, or spacing, of the delay elements 112 and the reflector element 110, enables the reflected surface acoustic wave to be delayed and/or adjusted, in its amplitude/frequency/phase, during its propagation in such a manner that the outgoing electrical signal 70 is characteristic, such that the anchor device can be identified by the external device 60 on the basis of the outgoing electrical signal 70.

Other arrangements of the communication interface 100, or of the surface-wave unit 102, on the anchor device 10 are also conceivable. The communication interface 100 may be arranged in the free region 26 or in the fastening region 20. In the free region 26, it is conceivable, for example, for the communication interface 100 to be arranged on a circumferential surface of the main body 28 and/or on the tension-absorbing element 30. In fastening region 20, it is conceivable, for example, for the communication interface 100 to be arranged on the circumferential surface of the main body 28, in particular between the bulge 38 and the tension-absorbing element 30. It is also conceivable for the communication interface 100 to be arranged on the end face 72 of the anchor device 10, which is located at the front end 22 of the anchor device 10 and extends perpendicularly in relation to the longitudinal axis 36 of the anchor device 10. It is also conceivable for the communication interface 100 to be arranged in the region of the bulge 48, or of the transition 50 of the bulge 50, and to face toward the inner surface 56 of the drill hole 14. It is also conceivable for the communication interface 100 to be arranged on an inner surface of the fastening element 33 or on the outer surface 54 of the fastening element 33.

Depending on the arrangement of the communication interface 100 on the anchor device 10, it is also conceivable for the outgoing electrical signal 70 to provide at least one further item of information. For example, the surface acoustic wave may be influenced by the temperature or an applied pressure, applied shear forces, or the like. Changes to the characteristics of the surface acoustic wave in turn result in a change to the outgoing electrical signal 70, with physical measured variables, such as the temperature in the region of the surface-wave unit 102 or applied forces, being able to be ascertained via the external device 60 on the basis of the changes to the electrical signal 70.

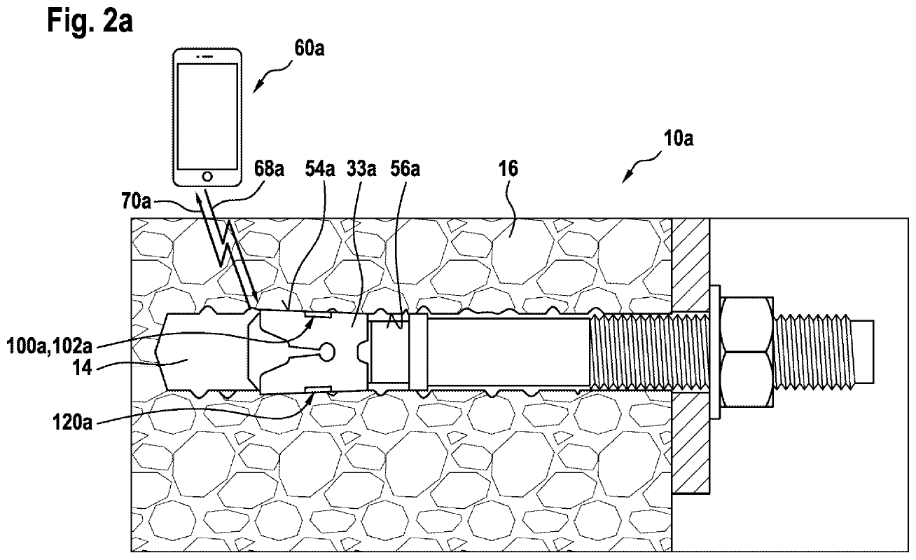

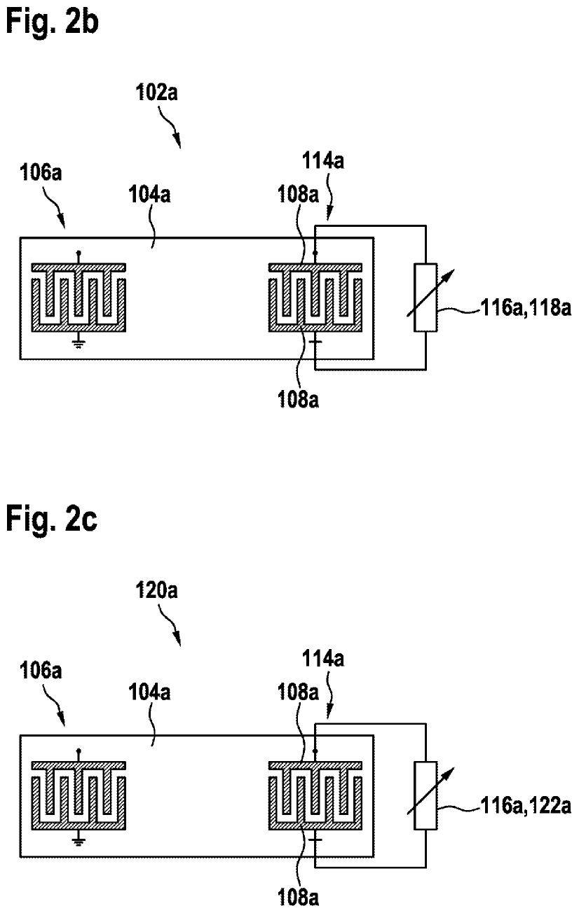

FIG. 2a shows a side view of a second embodiment of the anchor device 100. The anchor device 100a in this case differs, in particular, in the realization of the communication interface 100a and of the arrangement of the communication interface 100a on the anchor device 10a. The anchor device 100a is shown in the fastened state. The communication interface 100a is arranged, exemplarily, on the outer surface 54a of the fastening element 33a of the anchor device 10a. When the anchor device 10a is in the fastened state, the communication interface 100a, or the surface-wave unit 102a, applies a force to the inner surface 56 of the drill hole 14 in the workpiece 16.

The surface-wave unit 102a is explained in greater detail on the basis of the schematic layout shown in FIG. 2b. The surface-wave unit 102a is realized as a “two-port resonator” known to the persons skilled in the art. The surface-wave unit 102a has a first electrode structure 106a and a second electrode structure 114, which are arranged on the same piezoelectric element 104a. The first electrode structure 106a and the second electrode structure 114a are realized as interdigital transducers. The first electrode structure 106a is designed to convert an incoming electrical signal 68a provided by an external device 60a into a surface acoustic wave. The surface acoustic wave propagates on the piezoelectric element 104a to the second electrode structure 114a.

The second electrode structure 114a is designed to convert an incoming surface wave into an outgoing electrical signal 70a that provides information to the external device 60a. The second electrode structure 114a comprises two electrically conductive elements 108a that engage in each other in a finger-like manner. The second electrode structure 114a is connected to a sensor 116a. The sensor 116a is realized as a capacitive sensor 118a. In particular, the sensor 116a is realized as a pressure sensor. The sensor 116a is realized in such a manner that a pressure acting upon the surface-wave unit 102a, or upon the sensor 116a, causes a change in the capacitance of the sensor 116a. In particular, the sensor 116a is connected to the second electrode structure 114a in such a manner that a change in the capacitance of the sensor 116a causes a change in the capacitance of the sensor 116a causes a change in the capacitance of the second electrode structure 114a. A change in the capacitance of the second electrode structure 114a causes a change in the outgoing electrical signal 70a, such that information regarding the applied pressure is provided via the outgoing electrical signal 70a. Advantageously, the pressure applied to the surface-wave unit 102a can be used to ascertain how good the fastening of the anchor device is, and thus an anchor state. Advantageously, for this purpose the communication interface 100a, or the surface-wave unit 102a, is arranged in such a manner that a force acting from the main body 28a upon the fastening element 33a, or a force acting from the fastening element 33a upon the workpiece 16, can be measured. Thus, an arrangement on the main body 28a as well as on the fastening element 33a of the anchor device 10a is conceivable.

The anchor device 10a may have one or more surface-wave units. The surface-wave units in this case may be designed to provide the same or different information.

By way of example, the anchor device according to FIG. 2a has a second surface-wave unit 120a, which is likewise arranged on the outer surface 54a of the fastening element 33a of the anchor device 10a. A schematic layout of the second surface-wave unit 120a is shown in FIG. 2c. The second surface-wave unit 120a is substantially similar in structure to the previously described surface-wave unit 102a having first and second electrode structures 106a, 114, but differs in the sensor 116a connected to the second electrode structure 114a. The sensor 116a of the second electrode structure 114a of the second surface-wave unit 120a is realized as a resistance-dependent sensor 122a. In particular, the sensor 116a of the second surface-wave unit 120a is realized as a humidity sensor, the resistance of the resistance-dependent sensor 122a changing in dependence on the humidity in the region of the second surface-wave unit 120a. In particular, the sensor 116a is connected to the second electrode structure 114a of the second surface-wave unit 120a in such a manner that a change in the resistance of the sensor 116a causes a change in the resistance of the second electrode structure 114a. A change in the resistance of the second electrode structure 114a causes a change in the outgoing electrical signal 70a, such that information relating to the moisture is provided via the outgoing electrical signal 70a. Advantageously, information regarding the condition of the workpiece can thereby also be provided via the communication interface 100a.

Alternatively, it would also be conceivable for the anchor device 10a to comprise two, three or more surface-wave units 102a having sensors 116a, realized as capacitive pressure sensors 118a, which are preferably evenly spaced in the circumferential direction in order, advantageously, to ascertain the force on different sides of the anchor device 10a.

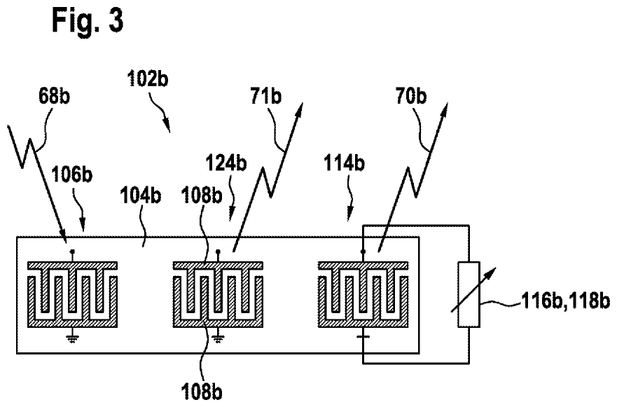

FIG. 3 shows a schematic layout of an alternative embodiment of the surface-wave unit 102a. The surface-wave unit 102b has a first electrode structure 106b and a second electrode structure 114b, which are arranged on a piezoelectric element 104b. Furthermore, the surface-wave unit 102b comprises a reference element 124b, which is likewise arranged on the piezoelectric element 104b. The first electrode structure 106b is designed to convert an incoming electrical signal 70b provided by an external device into a surface acoustic wave. The surface acoustic wave propagates on the piezoelectric element 104b to the second electrode structure 114b and to the reference element 124b. The second electrode structure 114b is designed to convert an incoming surface wave into an outgoing electrical signal 70b that provides information to the external device. The second electrode structure 114b is connected to a sensor 116b. The sensor 116b is realized as a capacitive sensor 118b. The reference element 124b comprises two electrically conductive elements 108b that engage in each other in a finger-like manner. The reference element 124b is designed to convert an incoming surface wave into an outgoing electrical reference signal 71b that provides reference information to the external device. Advantageously, comparison of the electrical signal 70b of the second electrode structure 114b and the electrical reference signal 71b of the reference element 124b allows more precise information can be ascertained.

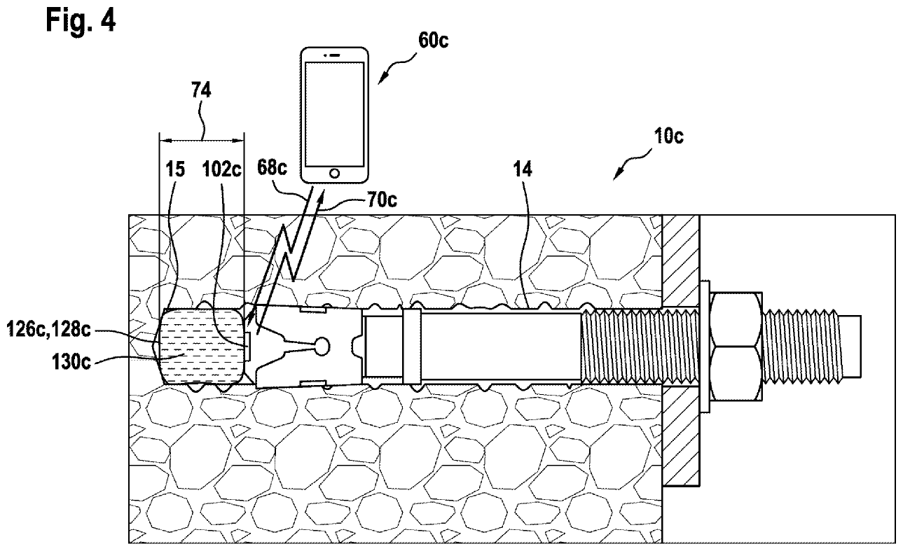

FIG. 4 shows a side view of an alternative anchor device 10c. The anchor device 10c has a communication interface 100c having a surface-wave unit 102c, which is arranged at the front end 22c of the anchor device 10c, in particular at the end face 72c of the main body 28c of the anchor device 10c. The surface-wave unit 102c corresponds substantially to the surface-wave unit 102b of the previous embodiment, with a sensor realized as a capacitive pressure sensor. The anchor device 10c is shown in a fastened state, with the anchor device 10c not completely filling the drill hole 14 axially, such that there is a cavity 15 between the anchor device 10c and the drill hole 14. A length 74 of the cavity 15 corresponds substantially to a difference between a drill-hole depth of the drill hole 14 and a penetration depth of the anchor device 10c. A diameter of the cavity 15 substantially corresponds substantially to a diameter of the drill hole 14.

An elastic 126b is arranged in the cavity 15 so as to substantially fill the cavity 15. The elastic element may be inserted before the anchor device 10c is inserted into the drill hole 14, or at the front end 22 of the anchor device 10c, in order to insert the elastic element 126b together with the anchor device 10c into the drill hole 14. The elastic element 126b is realized, exemplarily, as a balloon element and has a plastic sheath 128b in which a compressible liquid 130b is enclosed. In the unstressed state, the elastic element 126b has a greater volume than the cavity 15. In the fastened state, the elastic element 126b lies on one side against the drill hole base and on an opposite side against the anchor device 10c, in particular against the surface-wave unit 102c, and is thereby compressed.

Depending on the degree of compression of the elastic element 126b, a force exerted by the elastic element 126b acts upon the anchor device 10c, in particular upon the surface-wave unit 102c. This force influences the outgoing electrical signal 70c as described above, which is provided to the external device and which, on the basis of the electrical signal 70c, can ascertain the penetration depth of the anchor device 10c and/or the distance of the anchor device 10c from the drill hole base.

1. An anchor device comprising:
a communication interface configured to provide information to an external device, the communication interface including at least one surface-wave unit configured to generate a surface acoustic wave.

2. The anchor device as claimed in claim 1, wherein the surface-wave unit comprises a piezoelectric element and at least one first electrode structure that are connected to each another in such a manner that (i) an incoming electrical and/or magnetic signal generates a surface acoustic wave, and/or (ii) an incoming surface acoustic wave generates an outgoing electrical and/or magnetic signal.

3. The anchor device as claimed in claim 1, wherein the surface-wave unit comprises at least one reflector element and/or one delay element.

4. The anchor device as claimed in claim 1, wherein the surface-wave unit comprises at least one reference element.

5. The anchor device as claimed in claim 2, further comprising:
a sensor,
wherein the surface-wave unit comprises at least a second electrode structure connected to the sensor.

6. The anchor device as claimed in claim 5, wherein the sensor is configured to effect a change in a capacitance, an inductance and/or a resistance of the second electrode structure in dependence on a physical measured variable.

7. The anchor device as claimed in claim 1, further comprising:
a main body that, in a fastened state, is arranged at least partially in a drill hole,
wherein the surface-wave unit is arranged, on the main body.

8. The anchor device as claimed in claim 7, further comprising:
at least one fastening element that is movable relative to the main body,
wherein the surface-wave unit is arranged on the fastening element.

9. A system comprising:
an anchor device as claimed in claim 1; and
an elastic element configured to be arranged in a drill hole in such a manner that the elastic element is in contact with the surface-wave unit.

10. A washer or nut comprising:
a communication interface configured to provide information to an external device, the communication interface including at least one surface-wave unit configured to generate a surface acoustic wave.

11. A method comprising:
transmitting information from an anchor device to an external device, the transmitting including:
receiving a first electrical and/or magnetic signal with the anchor device;
generating a surface acoustic wave with the anchor device; and
sending a second electrical and/or magnetic signal with the anchor device.

12. The method as claimed in claim 11, further comprising:
reading-out the information from the anchor device, the reading out comprising:
receiving the second electrical and/or magnetic signal of a surface-wave unit of the anchor device with an external device;
ascertaining at least one item of the information from the anchor device based on the second electrical and/or magnetic signal, with the external device.

13. The method as claimed in claim 12, wherein the at least one item of the information is ascertained on the basis of a frequency, a velocity, a phase and/or an amplitude of the surface acoustic wave.

14. The external device configured to execute the method as claimed in claim 12.

15. The anchor device as claimed in claim 1, wherein the anchor device is a bolt anchor or an expansion plug.
